(19) United States
(12) Patent Application Publication
(10) Pub. No.: US 2005/0017036 A1
(43) Pub. Date: Jan. 27, 2005

(54) Device for keeping items in a vehicle in position

(76) Inventors: Thomas Dahl, Lerum (SE); Todd Levy, Thousand Oaks, CA (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/610,972

(22) Filed: Jul. 1, 2003

(30) Foreign Application Priority Data
Jun. 26, 2002 (EP) 02014218.8

(51) Int. Cl. B60R 7/00; B60R 9/00; B60R 11/00

(52) U.S. Cl. 224/275; 224/510

(57) ABSTRACT

A device for keeping items in a vehicle in position wherein the device includes a fabric defining at least one recess for receiving said items. The device is movable between a first position, wherein the recess is accessible for receiving said items, and a second position wherein the recess is hidden and inaccessible for receiving said items. A spring forces the device from the first position to the second position.

### FIELD OF THE INVENTION

The present invention relates to a device for keeping items in a vehicle in position.

### BACKGROUND OF THE INVENTION

Several devices of the above mentioned type are known. Cup and can holders are most common and usually installed in the front panel or the bracket between the front seats of most new vehicles. However, for larger containers, such as bottles with a volume of, for example, 1 to 2 liters, these holders are insufficient.

Efforts have been made to make a holder for larger containers and have resulted in a plastic disk with a recess wherein the recess has a diameter larger than the diameter of the container. The plastic disk is arranged between the back seat and the bracket between the two front seats of a vehicle and at a distance from the vehicle floor. The container is simply put into the recess of the plastic disk keeping the balance of the bottle and through the recess until the container rests on the floor of the vehicle. However, the disk is easily brought out of position, for example by a leg of someone sitting in the backseat, and is not easily put back into position. Further, the result is in most cases the container tipping over.

### SUMMARY OF THE INVENTION

In view of the issues in the related art as set forth above, one of the objects of the present invention is to provide an improved device for keeping various items, especially liquid containers, in position in vehicles. This object is achieved by the present invention.

According to the present invention, the device includes at least one recess for receiving the items, whereby the device is movable between a first position, wherein the recess is accessible for receiving said items, and a second position wherein the recess is hidden and inaccessible for receiving said items. A spring forces the device from the first position to the second position. The device includes a fabric with a recess. Instead of a fabric, a spring band steel can be used. However, the term “fabric” should be construed to include, but not be limited to, a weave, net, band, belt, cord or strap made of some plastic or textile. It is also possible to use a flexible fabric. In case the device comprises a fabric, if the device according to the present invention is unintentionally, or intentionally, pushed or hit the device will briefly be bent out of shape but immediately return to its original shape. Thus, re-positioning of the device is automatic with the present invention. This is made possible due to the spring force applied in a direction from the first position to the second position of the device. Hereinafter, the term “fabric” is used and is intended to encompass a textile, steel band spring or the like.

The recess is a through hole in the fabric. When in the second position, the fabric is essentially rolled up and thus the through hole is inaccessible. Since the spring force is in the direction from the first position to the second position, the fabric being in a retracted position is equivalent to being in said second position. The spring force can be applied by a spring in a retractor roller. Another possibility is that the spring can be the fabric itself, for instance, a spring band steel or an elastic fabric. When the device is to be used, the fabric is pulled out and thus the through hole in the fabric is made accessible.

The shape of the recess is preferably circular since most liquid containers have circular cross-sections, but other polygon shapes are possible, such as a square in order to hold, for example, a tetrahedral package with orange juice.

According to one aspect of the present invention, since the containers might be shaped in several ways, the recess is provided with a flexible material for better grip on the item being held in position with the holder. This will make it possible for a holder with a circular recess to hold an item with for example a square cross-section. Conversely, the holder can have a square recess and still hold an item with circular cross-section.

According to another aspect of the present invention, a fastening device is utilized to prevent the fabric from being pulled back into the retracted position. Preferably, the fastening device is a thin elongate pin arranged in the plane of the fabric and perpendicular to the extraction direction of the fabric. When the holder is to be used the fabric is pulled out from the retracted position and the pin is secured in said first position with hooks arranged in the front of the back seat, the hooks gripping the ends of the pin.

Further, according to another aspect of the present invention, the fabric comprises a recess by the coupling device for facilitating the gripping of the fastening device. Preferably, the recess is large enough to allow for at least one or two fingers of a user, pulling the fabric out, in the recess. Thus, when pulling the fabric out, the pin is pulled and put behind the hooks at the back seat.

According to yet another aspect of the present invention, a recess is formed in the floor of the vehicle, and when the holder is in use, under the recess of the fabric for further stability of the item kept in the holder.

### BRIEF DESCRIPTION OF THE DRAWINGS

The invention is further explained below with reference to the drawings, wherein:

FIG. 1a is a perspective view of a part of the interior of a vehicle showing an embodiment of the holder according to the present invention in retracted position;

FIG. 1b is a perspective view of a part of the interior of a vehicle showing the holder from FIG. 1a in use holding a bottle;

FIG. 1c is a perspective view of a part of the interior of a vehicle showing an alternative embodiment of the holder according to the present invention in use holding a bottle;

FIG. 1d is a perspective view of a part of the interior of a vehicle showing the holder from FIG. 1c in use holding a tetrahedral package;

FIG. 2a is a cross-sectional view of the holder from FIG. 1a in retracted position;

FIG. 2b is a cross-sectional view of the holder from FIG. 1b in use holding a bottle;

FIG. 3a is a top view of one embodiment of the fabric showing the end with the fastening device;

FIG. 3b is a top view of an alternative embodiment of the fabric showing the end with the fastening device.

### DESCRIPTION OF PREFERRED EMBODIMENTS

Hereinafter, embodiments of the present invention will be explained in detail with reference to the accompanying drawings.

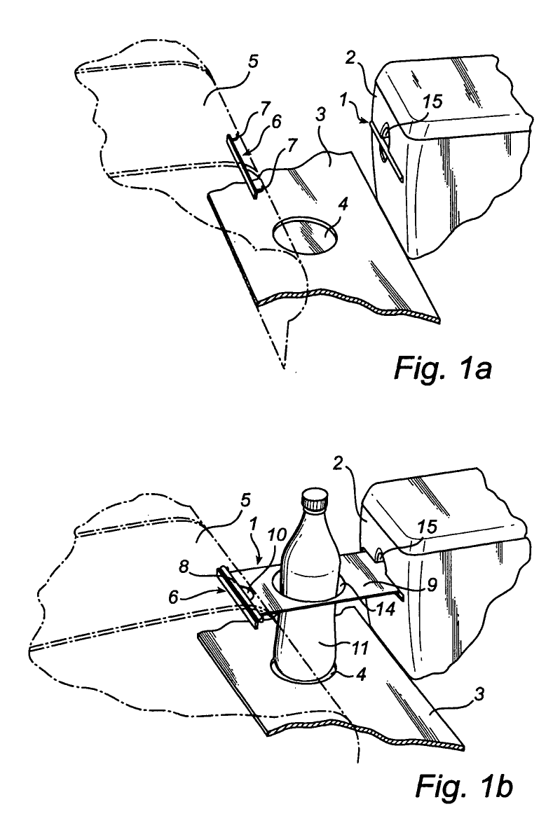

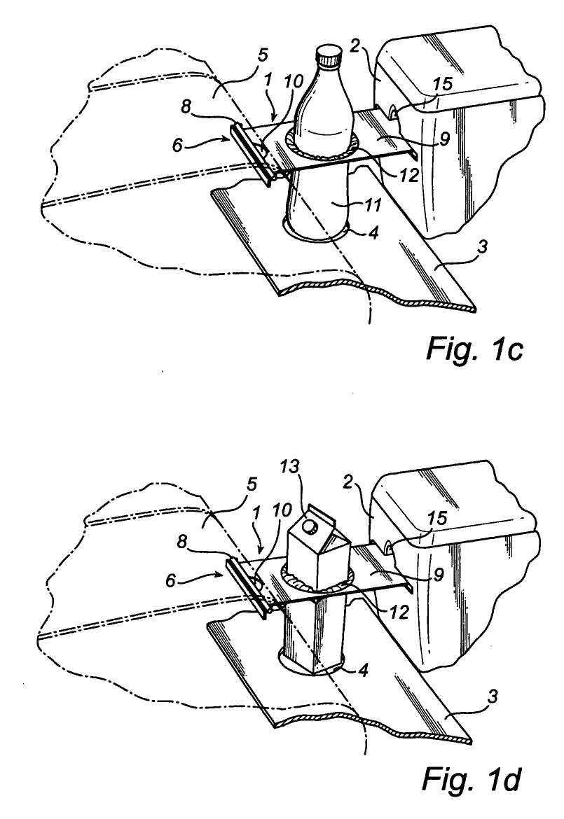

FIGS. 1a and 1b show an embodiment of the present invention where the holder 1 is arranged in a vehicle such that it is intended to be mounted between the bracket 2, the bracket 2 between the two front seats, and the back seat 5 of a vehicle. At the back seat 5 is arranged a device 6 with hooks 7 corresponding to the fastening device 8, henceforth referred to as “pin”. When the holder 1 is in use the recess 14 in the fabric 9 is located straight above the recess 4 in the floor 3 of the vehicle. FIG. 1b shows the holder 1 holding a bottle 11. The recess 14 in the fabric 9 is in this embodiment circular, but it is possible to have other shapes of the recess 14. Preferably an additional recess 10 is arranged in the fabric 9 adjacent to the pin 8. The main purpose of this recess 10 is to facilitate mounting the holder, i.e. to make it easier gripping the pin 8 when pulling the fabric 9 out from the retractor roller. Preferably a corresponding recess 15 is arranged in the bracket 2 to further facilitate gripping the pin 8 and consequently the fabric 9.

FIGS. 1c and 1d show an alternative embodiment of the present invention where the recess 14 of FIGS. 1a and 1b is provided with a flexible material 12 in order to hold an item 11, 13 more firmly in place. In FIG. 1d the holder 1 is holding a tetrahedral package 13 even though the recess of the fabric 9 is circular. One alternative is of course to have a square recess in the fabric 9 provided with flexible material in order to be able to hold items with any kind of cross-section. The recess in the fabric 9 can further be of any shape.

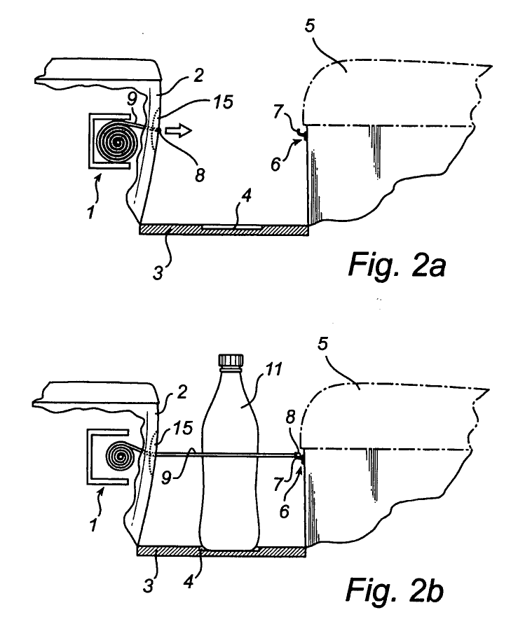

The length of the fabric 9 is preferably longer than the distance between the back seat 5 and the bracket. FIGS. 2a and 2b show the holder 1 from the side in a cross-sectional view in retracted and extracted position, respectively. When the holder 1 is in use, see FIG. 2b, enough fabric 9 is preferably still left on the roller in order to allow pulling out at least a few centimeters more of fabric. This is to ensure that not to much load is applied on the device 6 and the retractor roller in case the fabric is, for example, stepped on or pulled in some other way. Preferably, the fabric 9 is long enough to be pulled out all the way along down to the floor 3 of the vehicle, along the floor 3 and up from the floor 3 to the device 6.

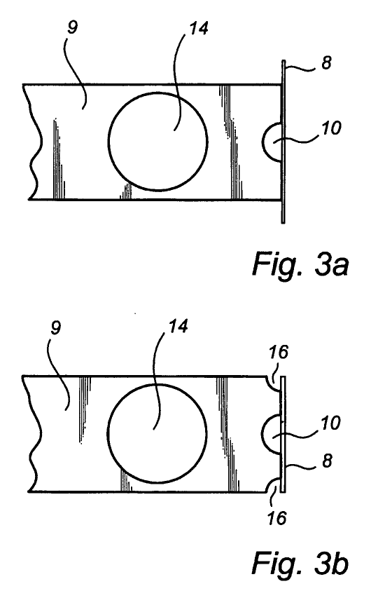

FIGS. 3a and 3b show two further alternative embodiments of the holder 1 and more specifically the length of the pin 8. FIG. 3a shows an embodiment where the length of the pin 8 is greater than the width of the fabric 9. The hooks 7 of the device 6 are in this case correspondingly spaced from each other to grip the pin 8 at the ends outside the fabric 9. In FIG. 3b the length of the pin 8 is essentially the same as the width of the fabric 9. In this case recesses 16 are arranged in the fabric 9 at the ends of the pin 8 to enable the hooks 7 of the device 6 to grip the pin 8.

The foregoing is a disclosure of preferred embodiments for practicing the present invention. However, it is apparent that device incorporating modifications and variations will be obvious to one skilled in the art. Inasmuch as the foregoing disclosure is intended to enable one skilled in the art to practice the instant invention, it should not be construed to be limited thereby, but should be construed to include such modifications and variations as fall within its true spirit and scope.

By way of example, the fastening device can be varied using, for example, a hook-and-loop fastener or a magnet coupling. Further, the holder according to the present invention could also be used to hold items in the luggage compartment of a vehicle. A holder with several recesses in the fabric is also a possible option, especially where the fabric can be stretched over a longer distance than between the backseat and the middle bracket of a vehicle, such as in a luggage compartment.

1. A device for keeping items in a vehicle in position, comprising:
a fabric defining at least one recess for receiving said items; and
a spring wherein the spring moves the fabric from a first position to a second position.

2. The device according to claim 1, wherein the device is essentially rolled up in said second position.

3. The device according to claim 2, wherein said spring is a spring loaded retractor roller.

4. The device according to claim 2, wherein said fabric is a spring band steel defining said recess.

5. The device according to claim 1, wherein the recess is provided with flexible material for better grip on the items being held in position with the device.

6. The device according to claim 1, wherein the device further comprises a fastening device.

7. The device according to claim 6, wherein the fastening device is a thin elongate pin arranged in the plane of the device.

8. The device according to claim 7, wherein the device further comprises a recess defined by a first member of the fastening device for maintaining the position of the thin elongate pin when the device in the first position.
